(19) United States
(12) Patent Application Publication
(10) Pub. No.: US 2007/0221322 A1
(43) Pub. Date: Sep. 27, 2007

(54) Method of manufacturing an integral article comprising a fiber-reinforced composite material, and a tool assembly for making the same

(75) Inventors: Peter Greis, Linkoping (SE); Max Krogager, Linkoping (SE); Mikael Petersson, Linkoping (SE); Bjorn Wiedmann, Borensberg (SE); Torbjorn Alenby, Linkoping (SE)

Correspondence Address: ALBIHNS STOCKHOLM AB, BOX 5581, LINNEGATAN 2, SE-114 85 STOCKHOLM; SWEDENn, STOCKHOLM, SE

(73) Assignee: SAAB AB, Linkoping (SE)

(21) Appl. No.: 11/609,344

(22) Filed: Dec. 12, 2006

(30) Foreign Application Priority Data
Dec. 20, 2005 (EP) 05112451.9

(51) Int. Cl. B29C 65/00

(52) U.S. Cl. 156/285; 156/307.1; 156/382

(57) ABSTRACT

The invention relates to a method of manufacturing an integral article comprising a fiber-reinforced composite material. An inner tool body (12) of a cellular plastic material is provided, onto which an airtight sheet (14) of a flexible material is applied so as to fully encompass and seal the tool body (12). A plurality of layers (16) of fiber-reinforced composite material are then applied onto the outer surface of the airtight sheet (14), and an airtight vacuum bag (18) is in turn applied onto the outer layer of the composite material (16). The vacuum bag (18) is evacuated and the layers (16) of composite material compressed. The composite material is heat treated so as to cure the same. The vacuum bag (18) is then removed from the thus formed article. To form a hollow integral tank, the formed article is provided with a hole (22), and a solvent is poured therein to dissolve the cellular plastic material. The dissolved material is then drained through the hole (22), and the airtight sheet (14) is possibly removed therethrough.

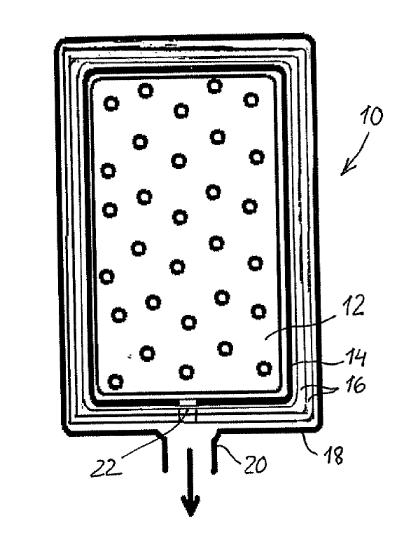

### FIELD OF THE INVENTION

The present invention relates to a method of manufacturing an integral article comprising a fiber-reinforced composite material, such as a fuel tank. The invention also relates to a tool assembly for the manufacture of such an article.

### BACKGROUND OF THE INVENTION

The manufacture of, for example, a hollow or shell-like article of fiber-reinforced composite material, such as a fuel tank for a vehicle or an aircraft, has so far required very strong and expensive inner tool components to be able to withstand high vacuum forces applied thereto which are necessary to obtain a poreless composite laminate during the manufacture. This is especially true when forming an integral fuel tank, i.e. a tank in one single piece, to keep the manufacturing costs low. Also, the tool components used are often difficult to remove from the finished formed article. A desired and ideal choice of material for such inner tool components would be a cellular plastic material, as it is extremely inexpensive, has a low density and would easily be dissolved after thermosetting/curing of the product. However, inexpensive cellular plastic material has a very low resistance to pressure and would easily collapse should vacuum be applied to a vacuum bag surrounding a body of cellular plastic.

### SUMMARY OF THE INVENTION

It is an object of the present invention to suggest a method which would make it possible to use an inexpensive soft cellular plastic material, such as foamed polystyrene, e.g. so called “Frigolif” or the like, as an inner forming tool when making a hollow or a shell-like article from a fiber-reinforced composite material. To this end the method of the invention is characterized by the steps set forth in the accompanying independent claim 1.

Due to the fact that an airtight sheet of a flexible material is applied to the tool body so as to fully encompass and seal the same, the air pressure within the airtight sheet will efficiently balance the air pressure on the outside of the vacuum bag when the latter is applying a vacuum pressure onto the composite material, i.e. between the two air tight layers, thereby preventing the cellular plastic material of the tool body to collapse as it is not exposed for any compressive pressure. This will allow for a very simple and inexpensive manufacturing of fully closed, integral articles of composite materials where the inner cellular plastic tool body may be left in situ as a “fly away tool”.

In case the article to be produced is a fuel tank, a hole may be drilled through the cured composite material, through which a suitable solvent, such as acetone, is poured so as to rapidly and easily dissolve the cellular plastic material within the airtight sheet. The dissolved cellular plastic material may then be drained through the drilled hole, and the airtight sheet can also be removed through the hole. The hole may then be used for a fuel filler connection of the tank.

The present invention also includes a tool assembly for carrying out the method of the invention as described herein and defined in the independent claim 6, as well as an article manufactured in accordance with the inventive method.

The invention will be described more in detail below in conjunction with the attached drawing.

### BRIEF DESCRIPTION OF THE DRAWING

The single FIGURE schematically discloses a cross-sectional view of a tool assembly of the present invention for making an integral, hollow article of a fiber-reinforced composite material.

### DETAILED DESCRIPTION OF PREFERRED EMBODIMENTS

In the drawing figure, 10 generally denotes a tool assembly of the invention used for making an integral, shell-like article of a fiber-reinforced composite material. The tool assembly comprises an inner tool body 12 of a soft cellular plastic material having an outer configuration that substantially corresponds to an inner configuration of the composite material article to be manufactured.

The procedure for manufacturing the article is as follows: first, an airtight sheet 14 of a flexible material, such as “TOOL TECH”, is applied onto the outer surface of the tool body 12 to fully encompass and seal the same. Then, a plurality of layers 16 of fiber-reinforced composite material, such as carbon fiber epoxy, having the fibers alternately oriented in various directions are applied onto the outer surface of the flexible airtight sheet 14 until a shell of sufficient thickness is obtained. Thereafter, an airtight vacuum bag 18 having an opening or evacuation connection 20 is applied thereto so as to fully encompass the layers 16 of the composite material. The vacuum bag 18 is then evacuated by a vacuum source (not shown) through the connection 20, so that all air between the airtight bag 18 and the airtight sheet 14 is disposed of, thereby compressing the layers 16 of the composite material to a poreless, air-free shell. Owing to the fact that the airtight sheet 14 is sealing the tool body 12 of porous cellular plastic material, the air pressure within the airtight sheet 14 will efficiently balance the air pressure on the outside of the vacuum bag 18 when the latter is applying a vacuum pressure onto the composite material 16, thereby preventing the cellular plastic material of the tool body 12 from collapsing as it is not exposed for any substantial compressive pressure. The tool assembly 10 is then subjected to a heat treatment in order to cure the layers 16 of composite material, and the vacuum bag 18 is removed from the thus hardened integral article. Depending on the intended use of the finished article, the tool body 12 and the airtight sheet 14 may either be left in situ as a so called “fly away tool”, or, in case the article to be produced is a container or a fuel tank, a hole 22 may be drilled through the cured composite material 16, through which a solvent, such as acetone, is poured so as to rapidly and easily dissolve the cellular plastic material of the tool body 12 within the airtight sheet 14. The dissolved cellular plastic material may then be drained through the hole 22, and the airtight sheet 14 can also be removed through the hole 22. The hole 22 may then be used for a fuel filler connection of the tank.

The invention is not limited to the embodiment described above but may be modified within the scope of the accompanying claims. However, it should be noted that, although the preferred tool body material is a cellular plastic material, it is conceivable that any equivalent dissolvable material, that is a light-weight porous material of low compression strength, such as foamed plastic, may be used for the same inventive purpose.

1. A method of manufacturing an integral article comprising a fiber-reinforced composite material, comprising the steps of:
providing an inner tool body (12) of a cellular plastic material having an outer configuration substantially corresponding to an inner configuration of the composite material article to be manufactured;
applying onto the outer surface of the tool body (12) an airtight sheet (14) of a flexible material fully encompassing the tool body (12);
applying onto the outer surface of the flexible airtight sheet (14) a plurality of layers (16) of fiber-reinforced composite material;
applying onto the outer layer of the composite material (16) an airtight vacuum bag (18);
evacuating the air enclosed within the vacuum bag (18), i.e. between the vacuum bag (18) and the flexible airtight sheet (14);
curing the composite material (16); and
removing the vacuum bag (18) from the thus formed article.

2. The method of claim 1, comprising the further steps of:
drilling at least one hole (22) in the composite material (16);
pouring a solvent into the at least one hole (22) to dissolve the cellular plastic tool body (12); and
draining the dissolved cellular plastic material from the interior of the article.

3. The method of claim 2, comprising the further step of removing the airtight sheet (14) from the article through the at least one hole (22).

4. The method of claim 2 or 3, wherein the cellular plastic used is dissolvable by acetone.

5. The method of anyone of claims 2-4, wherein the article produced is a fuel tank.

6. A tool assembly (10) for the manufacture of an integral article of a fiber-reinforced composite material, comprising an inner tool body (12) of a cellular plastic material, a flexible airtight sheet (14) fully encompassing the tool body (12), and an airtight vacuum bag (18) configured to encompass a shell (16) of a fiber-reinforced composite material laid onto the airtight sheet (14), said vacuum bag (18) having at least one evacuation connection (20) for the evacuation of air enclosed within the vacuum bag (18), i.e. between the vacuum bag (18) and the flexible airtight sheet (14).

7. An article produced according to the method of anyone of claims 1-5.
